(19) United States
(12) Patent Application Publication
(10) Pub. No.: US 2009/0138996 A1
(43) Pub. Date: May 28, 2009

(54) MICROTIPS AND NANOTIPS, AND METHOD FOR THEIR PRODUCTION

(76) Inventors: Jorn Volkher Wochnowski, Norderstedt (DE); Carsten Wochnowski, Norderstedt (DE); Dominique Pascal Eyidi, Pointiers (FR); Jurgen Heck, Ahrensburg (DE); Barbara Albert, Darmstadt (DE)

Correspondence Address: HOVEY WILLIAMS LLP, 10801 Mastin Blvd., Suite 1000, Overland Park, KS, 66210, US

(21) Appl. No.: 12/159,706

(22) PCT Filed: Dec. 28, 2006
(86) PCT No.: PCT/EP06/12588

§ 371 Date: Oct. 7, 2008

(30) Foreign Application Priority Data
Dec. 30, 2005 (DE) 10 2005 063 127.4

(51) Int. Cl. G01N 13/10; C07F 7/02; B32B 5/02; B82B 1/00; B82B 3/00

(52) U.S. Cl. 850/60; 556/466; 204/157.74; 204/157.61; 428/401; 977/700; 977/890; 977/902

(57) ABSTRACT

The present invention relates to a method for the production of tips, the order of magnitude of which lies in the micro- and/or nanometer range, comprising contacting a precursor material with a matrix and then energetically activating over a large area, wherein the precursor material contains an element other than carbon from the second to fifth main groups, the sixth main group with an atomic number Z≧16 or a sub-group of the periodic table of the elements and organic groups which are chemically bonded to the respective element directly and/or via an element of the sixth main group.

The present invention relates to a method for the production of microtips and nanotips and the tips that can be obtained by such a method and their use in scanning force microscopy or optical scanning near-field microscopy.

In particular microtips play a prominent role as components in microtechnology. As nanotechnology makes further advances, an ever-greater importance will also be accorded to nanotips, numerous aspects of application still being not wholly assessable from today's standpoint.

One field of application already generally known today for microtips and nanotips is in the area of microscopy and in particular in scanning probe microscopy (SPM) methods, in atomic force microscopy (AFM) methods or in scanning near-field optical microscopy (SNOM) methods. In such microscopes, microtips and nanotips are used as sensors with which the samples to be examined are scanned. It is known that the tips are produced with etching techniques developed in the semiconductor industry (M.-D. Weitze, Das Rasterkraftmikroskop, GNT-Verlag 2003, p. 30).

In these lithographic methods, a light-sensitive photoresist is usually first deposited on a substrate, lit and developed. The free intermediate spaces are then etched away by wet-chemical processes and the photoresist removed again (W. Ehrfeld, Handbuch Mikrotechnik, 1^{st} edition, Hanser Verlag 2002, p. 287 et seq. and p. 308 et seq.).

EP 1 359 388 A1 discloses for example a method for the production of sensor tips in which a silicon substrate covered with a silicon dioxide layer is used as starting material. In a first method step a small opening is produced in the oxide layer by a lithographic method followed by wet-chemical etching. A pit is then formed in the thereby exposed silicon substrate by means of a further etching solution. After a wet-chemical removal of the whole oxide layer and a scarfing of the pit silicon nitride is then introduced into the pit by precipitation from the gas phase (PECVD, plasma enhanced chemical vapour deposition) and forms the tip necessary for the sensor.

In addition to the large number of method steps, in particular the labour-intensive wet-chemical etching processes are problematic both from an ecological and economic point of view as they cannot manage without the use of strongly health hazardous chemicals such as e.g. hydrofluoric acid, which results in numerous safety requirements. These disadvantages of the known methods result in relatively high process costs for the production of microtips and nanotips. As the tips represent wearing parts in particular in scanning force microscopy and thus have a short service life, the effects of the high production costs prove to be particularly disadvantageous.

The object of the present invention is therefore to prepare needle-shaped tips, the order of magnitude of which is in the order of the micro- and/or nanometer range, which can be produced in cost-favourable manner, with few method steps and without the use of etching solutions that is associated with lithographic methods.

This object is achieved by a method for the production of needle-shaped tips according to claims 1 to 20. The invention also relates to tips according to claim 21 and the use of tips according to claims 22 to 23.

A needle-shaped tip within the meaning of this invention is any structure with a height significantly greater than its diameter. Generally the ratio of the height of the tip to the diameter or width of the tip is at least 2, preferably at least 5, in particular at least 10 and particularly preferably at least 20. In one embodiment the ratio of height to diameter ranges from 10 to 1000. The expression needle-shaped tip also covers in particular structures which are suitable to interact directly or indirectly with a surface to be examined (functional microtips and nanotips).

Furthermore the order of magnitude of the tips produced according to the invention is in the micro- and/or nanometer range, i.e. they measure 1000 μm at most. The tips are preferably 1 nm to 1000 μm high, in particular 30 nm to 20 μm, and have a diameter of 40 nm to 100 μm, in particular 60 nm to 1 μm. At the end of the tips the diameter can, however, also be smaller, such that tips with a tip diameter in the atomic range (0.1 nm) are also covered by the invention.

In the method according to the invention for the production of needle-shaped tips, the order of magnitude of which lies in the micro- and/or nanometer range, a precursor material is contacted with a matrix and then energetically activated over a large area, wherein the precursor material contains an element other than carbon from the second to fifth main groups, the sixth sub-group with an atomic number Z≧16 or a sub-group of the periodic table of the elements and organic groups which are chemically bonded to the respective element directly and/or via an element of the sixth main group.

The exposure to the action of energy brings about a chemical growth within the precursor material (also called precursor below) and thus the formation of tips. Chemical growth denotes chemical build-up reactions in which a conversion of materials takes place. Therefore the chemical compositions of the products and of the educts differ from one another during the chemical growth. A chemical growth process can be e.g. a sol-gel process, a polymerization or across-linking. The molecules can be activated either directly (e.g. photolytically or pyrolytically via single molecular groups or bonds) or indirectly (e.g. via photoinitiators or cross-linkers). In contrast to this, physical growth denotes physical processes (e.g. crystallization, molecular epitaxy, phase transition, general surface or layer precipitation) in which, although chemical conversions can also take place, the actual growth processes do not.

Firstly, the precursor material is contacted with a matrix. In this context matrix means any supporting substrate with a planar or curved surface. Precursor and matrix are then jointly energetically activated, i.e. subjected to a suitable energy source. A chemical growth process such as for example a polymerization or cross-linking is induced in the precursor material by the energy source. The energetic activation takes place over a large area, i.e. evenly and homogeneously over a large region of the sample, and not in a location-selective manner, i.e. not limited to a specific small region of the sample from which the tip structure is to form, e.g. by means of focusing a laser beam. It was surprisingly found that despite the energetic activation over a large area the chemical growth process takes place in spatially-limited manner and a localized formation of tips takes place. One reason for this local limitation of the chemical growth process could be the presence of inhomogeneities of the matrix or precursor material. Fluctuations in the energy flux are also a conceivable cause of the growth of tips. The result of these inhomogeneities can be curing processes varying in speed and/or type, which leads to internal stresses in the precursor material which are compensated by the surface of the precursor material deforming and tips thus forming.

A compound is used as precursor material which in addition to organic groups contains an element other than carbon from the second to fifth main groups, the sixth main group with an atomic number Z≧16 (S, Se, Te) or a sub-group of the periodic table of the elements and preferably an element selected from the group consisting of Si, Al, Ti, Zr, Ca, Fc, V, Sn, Be, B, P and mixtures thereof. The organic groups are chemically bonded to the respective element directly and/or preferably via an element of the sixth main group (O, S, Se, Te), particularly preferably via oxygen and are preferably selected from the group consisting of hydrogen, alkyl, allyl, aryl, hydroxyl and radicals with photosensitive and/or thermosensitive groups such as e.g. acrylates.

The precursor material is preferably selected from the group consisting of tetraethylorthosilicate (TEOS), tetramethylorthosilicate (TMOS), tetrabutoxysilane, triethoxyphenylsilane, methyltripropoxysilane, 1,2-bis(trimethoxysilyl)ethane, 1,2-bis(triethoxysilyl)ethane, phenethyltrimethoxysilane, isobutyltriethoxysilane, tris(2-methoxyethoxy)vinylsilane, octyltrimethoxysilane, phenyltriethoxysilane, octyltriethoxysilane, Al(O-iso-C₃H₇)₃, Ti(O-iso-C₃H₇)₄, Zr(O-t-C₄H₉)₄, Zr(O-n-C₄H₉)₄, Ca(O—C₂H₅)₂, Fe(O—C₂H₅)₃, V(O-iso-C₃H₇)₄, Sn(O-t-C₄H₉)₄, Be(O—C₂H₅)₂, B(O—C₂H₅)₃ and P(O—C₂H₅)₃ and derivatives (e.g. methyl, ethyl, isopropyl etc.) and mixtures thereof.

The precursor material must be able to adapt to the matrix serving as supporting substrate. To this end it is preferably liquid at room temperature. However, highly-viscous, gel-like or paste-like precursor materials can also be used.

In a preferred embodiment the compound used as precursor is represented by the formula

ER¹ₙ(-A-R²)ₘ,

wherein
E=is an element other than carbon from the second to fifth main groups, the sixth main group with an atomic number Z≧16 (S, Se, Te) or a sub-group of the periodic table of the elements,
A=is an element of the sixth main group of the periodic table (O, S, Se, Te), in particular oxygen,
R¹=is the same or different and is selected from the group consisting of hydrogen, alkyl, allyl, aryl, hydroxyl and radicals with photosensitive and/or thermosensitive groups such as e.g. acrylates,
R²=is the same or different and is selected from the group consisting of hydrogen, alkyl, allyl, aryl, hydroxyl and radicals with photosensitive and/or thermosensitive groups such as e.g. acrylates and,
n, m=independently of one another are 0, 1, 2, . . . and the sum of n and m corresponds to the valency of E.

In this formula the element E is in particular selected from the group consisting of Si, Al, Ti, Zr, Ca, Fe, V, Sn, Be, B and P. E is preferably an element of the fourth main group of the periodic table and most preferably silicon. The organic radicals R¹ are preferably hydrogen, C₁-C₈ alkyl and in particular C₁-C₄ alkyl or hydroxyl. R² is preferably C₁-C₈ alkyl and in particular C₁-C₄ alkyl.

In a particularly preferred embodiment of the method according to the invention tetraethylorthosilicate (TEOS) is used as precursor.

Other compounds such as for example dopants or colour centres (chromophoric groups) can also be added to the precursor material in the present method. The added dopants can cause the physical-chemical inhomogeneities necessary for the growth of the tips (e.g. local variations in the optical adsorption coefficient, heat capacity or thermal conductivity) in the precursor material in order to positively influence the growth process of the tips in a targeted manner. Moreover, the added dopants can optimize the functional properties (electric conductivity or optical transparency) and the mechanical properties (e.g. hardness, strength, roughness) of the produced microtips and nanotips.

With the method according to the invention the energetic activation of the precursor material takes place preferably through thermal or photolytic activation. While the photolytic activation takes place through irradiation, the thermal activation can take place through irradiation or heating.

In the case of an irradiation the precursor material is preferably irradiated with electromagnetic radiation of a wavelength up to 1000 μm maximum or with particle radiation of an energy up to 1000 GeV maximum. This means that the precursor can be irradiated both with UV, VIS and IR radiation. In particular the wavelength of the electromagnetic radiation used ranges from 100 to 380 nm and particularly preferably from 100 to 280 nm.

In a preferred embodiment the electromagnetic radiation used for irradiation is emitted by a UV excimer laser with a pulse duration of at least 1 ns, preferably 10 to 100 ns and particularly preferably 20 ns. In particular the irradiation takes place with a fluence of 1 to 1000 mJ/cm² per pulse. Furthermore, the irradiation preferably takes place with a repetition rate of at least 0.01 Hz and a laser pulse count of 1 to 20 000.

The precursor material according to the invention is preferably not transparent for the electromagnetic radiation used. In the case of a photolytic activation the photochemical processes and in particular single-photon processes thus take place on the surface of the precursor material.

In another embodiment of the invention the energy required for the formation of the tips is provided by heating. A hot plate or an oven is preferably used for this. In particular the precursor material is heated to a temperature of 299 K to 2075 K and preferably to 368 K to 605 K.

The process conditions of the method according to the invention, such as e.g. the temperature or the laser intensity during the energetic activation, are in principle suited to control the size of the formed tips.

The matrix used according to the invention, with which the precursor material is contacted before the exposure to the action of energy, serves as supporting substrate for the precursor. Under no circumstances does the matrix represent a so-called master structure which is usually produced with lithographic etching techniques and determines the number, size and shape of the tips to be formed directly as a negative mould. In particular the matrix used according to the invention does not have cavities in which the tips are formed. Instead, the planar or curved surface of the matrix is smooth.

The matrix can be a capillary into which the precursor material is introduced. The introduction or filling takes place usually by capillary forces or by the application of a negative pressure.

In one embodiment the capillary consists of glass.

If a capillary is used as a matrix in the method of the invention, it can be scaled at both ends after being filled with the precursor, but still before the exposure to the action of energy. Usually this sealing is brought about in particular in the case of glass capillaries by fusing at both ends. Furthermore, in the case where the energy input takes place by irradiation the capillary is preferably aligned vertically centred in relation to the through-beam of the irradiation, with the result that the energy input into the liquid is maximal.

Furthermore, in another embodiment a planar supporting substrate to which the precursor material is applied can be used as a matrix. This planar supporting substrate preferably consists of glass or it is a silicon wafer. In a further embodiment, after the coating of the planar supporting substrate with the precursor material, but still before the exposure to the action of energy, a further planar carrier is laid onto the matrix surface provided with the precursor. It is particularly preferred that when using a planar supporting substrate the energetic activation of the precursor material lakes place through heating.

Irrespective of the type of matrix and the type of exposure to the action of energy, the matrix and thus also the precursor material in contact with it preferably remain stationary during the exposure to the action of energy, i.e. they are not moved.

The formed tips can be treated with a vacuum after the irradiation or heating. The level of the applied vacuum is based on the vapour pressure of the precursor used and is preferably such that the precursor material not cured by the exposure to the action of energy and any readily volatile compounds can evaporate. If a capillary is used as matrix, the application of a vacuum can comprise the mechanical opening of the capillary on one side, for example by knocking or breaking open, the introduction of opened capillary into a vessel to be evacuated and then the build-up of a vacuum in the vessel to be evacuated.

The tips produced by the method according to the invention are preferably examined using common characterization methods. In particular the structure of the tips can be examined by means of scanning electron microscopy (SEM) and transmission electron microscopy (TEM). An analysis of the element-specific composition of the produced tips is possible by means of energy-dispersive X-ray analysis (EDX). These characterization methods are preferably carried out after the vacuum treatment described above.

In a further embodiment the formed tips can be separated at the end of the process from the precursor material not converted into tips. This separation takes place preferably with a highly energetic radiation such as that of an electron beam or of a focused gallium ion beam (focused ion beam or FIB) under 30 kV high voltage. However, a mechanical separation is also possible, for example with an ultramicrotome, with which sample sections of 50 nm thickness can be achieved.

Thus in a particularly preferred embodiment of the invention needle-shaped tips can be produced by:
(a) contacting a precursor material with a matrix,
(b) energetically activating the precursor material over a large area in order to form tips,
(c) optionally treating the formed tips with a vacuum,
(d) optionally analysing the formed tips and
(e) optionally separating a formed tip from other formed tips and from the precursor material not converted into tips.

Furthermore the invention relates to needle-shaped tips, the order of magnitude of which lies in the micro- and/or nanometer range and which can be obtained with the method of the present invention.

The needle-shaped tips according to the invention have a spatially inhomogeneous distribution of elements. This means that the chemical composition of a tip is not constant over its whole spatial extent. In particular the term “spatially inhomogeneous distribution of elements” means that the maximum difference between the levels of an element selected from carbon or oxygen at different positions of the tip is at least 10 wt.-% and/or the maximum difference between the levels of an element with an atomic number Z≧11 at different positions of the tip is at least 5 wt.-%. In particular this spatially inhomogeneous distribution of elements is caused exclusively by the production method according to the invention and not by a subsequent treatment such as e.g. coating, doping or diffusion processes. The level of an element is determined by means of energy-dispersive X-ray spectrometry (EDX, with a resolution of 130 eV at the Mn—Kα line) in a scanning electron microscope under 20 kV high voltage and with a silicon-lithium EDX detector. For example the distribution of elements in the tips is inhomogeneous if the difference between the level of oxygen at the end of the tip and the level of oxygen at the foot of the tip is at least 10 wt.-%.

The tips according to the invention predominantly have a cylindrical shape. The ends of the tips can be spherical or conical. Edge-shaped structures such as pyramidal tip ends or rectangular shapes are only rarely observed.

The invention is also directed towards the use of tips according to the invention as a component in microtechnology. In particular the tips can be used as a component in a microscope, wherein the use as sensor tips in scanning probe microscopes and scanning force microscopes or optical scanning near-field microscopes is particularly preferred.

The tips according to the invention can also be used as microprobes for writing and reading optical and magnetic data carriers, as embossing or master structures for the shaping or microprocessing of soft surfaces (e.g. pressing, stamping, scratching, boring, creating “via-holes”), as microelectrodes for the emission of electron radiation (e.g. field electron microscopy) or for microfuel cells or electrolysis cells, as crystallization points, as components of microactuators (e.g. stationary or mobile spacers, active or passive filters) or for building up functional surfaces such as e.g. lotus-like surface structures to repel dirt and reduce adhesion or surface tension.

The invention is now described in more detail using selected examples.

### EXAMPLES

### Example 1

### Filling the Capillaries

Glass capillaries 10 cm in length and with an internal diameter or 1 mm were filled with tetraethylorthosilicate (TEOS) by means of capillary forces by an applied negative pressure and sealed by fusing at both ends.

### 1^{st} Variant

A filled capillary was irradiated with a KrF excimer laser (wavelength=248 nm, pulse duration 20 ns, fluence=60 mJ/cm², repetition rate=1 Hz, number of laser pulses=3333). After the irradiation the capillary was mechanically opened and examined with a scanning electron microscope (LEO 1525, 5 kV accelerating voltage).

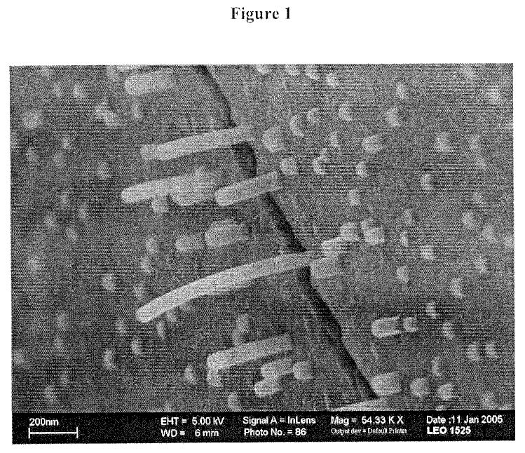

One of the thus-obtained scanning electron microscope photographs is reproduced in FIG. 1. As can be seen, a large number of tips of different lengths were produced which predominantly are 50 to 1000 nm high and have a diameter of 60 to 100 nm. However, tips with a greater height such as up to 2000 nm were also observed.

### 2^{nd} Variant

A filled capillary was irradiated with a KrF excimer laser (wavelength=248 nm, pulse duration 20 ns, fluence=20 mJ/cm², repetition rate=1 Hz, number of laser pulses=3333). After the irradiation this capillary was also mechanically opened and examined with a scanning electron microscope (LEO 1525, 5 kV accelerating voltage).

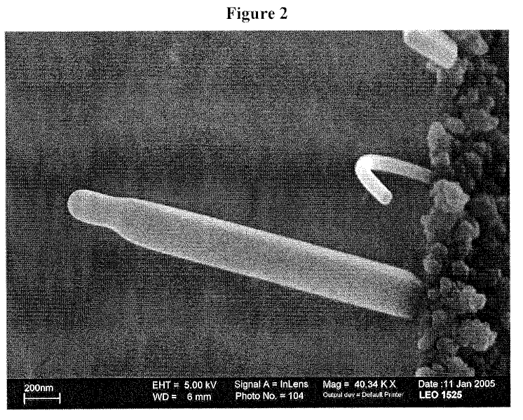

A microscope photograph is reproduced in FIG. 2 and shows a picture of a single tip, the end of which is more spherical than not.

### 3^{rd} Variant

A filled capillary was irradiated with a KrF excimer laser (wavelength=248 nm, pulse duration 20 ns, fluence=50 mJ/cm², repetition rate=1 Hz, number of laser pulses=5000). After the irradiation the capillary was mechanically opened and examined with a scanning electron microscope (LEO 1525, 5 kV accelerating voltage).

The taper of the ends of the tips produced in this variant is more conical than not.

### 4^{th} Variant

A filled capillary was irradiated with a KrF excimer laser (wavelength=248 nm, pulse duration 20 ns, fluence=50 mJ/cm², repetition rate=1 Hz, number of laser pulses=3000). After the irradiation the capillary was mechanically opened and examined with a scanning electron microscope (S-2500, 25 kV accelerating voltage).

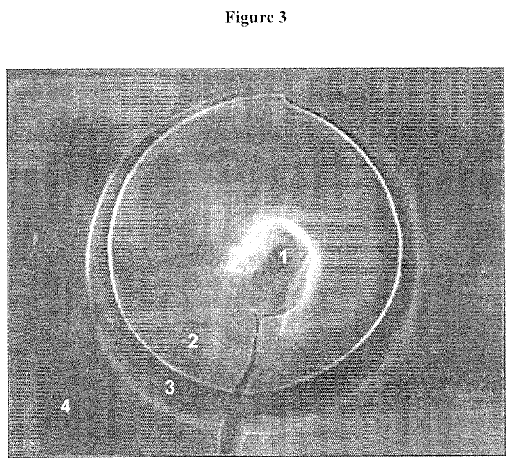

FIG. 3 shows a top view of a tip produced according to this variant. The tip was examined by means of EDX (energy dispersive X-ray analysis, Mn—Kα line, 130 cV resolution, 25 kV accelerating voltage) at the numbered spots. Number 1 denotes a point on the tip itself, i.e. on the end of the tip, number 2 a point on the side-surface of the needle, number 3 a point on the fracture zone, i.e. at the foot of the needle, and number 4 a point on the flat surface not converted into tips. The distribution of elements at these four positions is represented in Table 1.

TABLE 1
Distribution of elements at the four measured positions

| | Silicon | Oxygen | Carbon | Si:O | Si:C |
|---|---|---|---|---|---|
| Position | [wt.-%] | [wt.-%] | [wt.-%] | ratio | ratio |
| 1 | 12.76 | 50.56 | 36.69 | 0.25 | 0.35 |
| 2 | 23.67 | 42.68 | 33.64 | 0.55 | 0.70 |
| 3 | 19.38 | 37.52 | 43.11 | 0.52 | 0.45 |
| 4 | 1.54 | 55.02 | 43.44 | 0.03 | 0.04 |

The EDX measurements show a chemically non-stoichiometric composition of the material of the tip and thus a spatially inhomogeneous distribution of elements over the whole volume of the tip. These chemical inhomogeneities can be explained by a chemical growth process, from which in turn physical inhomogeneities (e.g. different density) can result.

### Example 2

### Deposition of the Precursor Material on a Planar Substrate Carrier

A small glass plate measuring 1 cm×1 cm and less than 1 mm thick was evenly coated with the precursor tetraethylorthosilicate (TEOS) by means of spin coating. A further small glass plate was then laid onto the coated surface.

### 1^{st} Variant

The coated small glass plate was placed on a hot plate and heated for two hours to 473 K. Following exposure to the action of heat, the small glass plate was examined with a scanning electron microscope and the formed tips characterized analytically.

1. Method for the production of tips by chemical growth, the order of magnitude of which lies in the micro- and/or nanometer range, characterized in that a precursor material is contacted with a matrix and then energetically activated over a large area, wherein the precursor material contains an element other than carbon from the second to fifth main groups, the sixth main group with an atomic number Z≧16 or a sub-group of the periodic table of the elements and organic groups which are chemically bonded to the respective element directly and/or via an element of the sixth main group.

2. Method according to claim 1, in which the precursor material contains an element selected from the group consisting of Si, Al, Ti, Zr, Ca, Fc, V, Sn, Be, B, P and mixtures thereof.

3. Method according to claim 1, in which the organic groups are selected from the group consisting of hydrogen, alkyl, allyl, aryl, hydroxyl and radicals with photosensitive and/or thermosensitive groups.

4. Method according to claim 1, in which the precursor material is selected from the group consisting of tetraethylorthosilicate (TEOS), tetramethylorthosilicate (TMOS), tetrabutoxysilane, triethoxyphenylsilane, methyltripropoxysilane, 1,2-bis(trimethoxysilyl)ethane, 1,2-bis(triethoxysilyl)ethane, phenethyltrimethoxysilane, isobutyltriethoxysilane, tris(2-methoxyethoxy)vinylsilane, octyltrimethoxysilane, phenyltriethoxysilane, octyltriethoxysilane, Al(O-iso-C₃H₇)₃, Ti(O-iso-C₃H₇)₄, Zr(O-t-C₄H₉)₄, Zr(O-n-C₄H₉)₄, Ca(O—C₂H₅)₂, Fe(O—C₂H₅)₃, V(O-iso-C₃H₇)₄, Sn(O-t-C₄H₉)₄, Be(O—C₂H₅)₂, B(O—C₂H₅)₃ and P(O—C₂H₅)₃ and derivatives and mixtures thereof.

5. Method according to claim 1, in which the precursor material used is represented by the formula
ER¹ₙ(-A-R²)ₘ,
wherein:
E=is an element different from carbon from the second to fifth main groups, the sixth main group with an atomic number Z≧16 or a sub-group of the periodic table of the elements,
A=is an element of the sixth main group of the periodic table, in particular oxygen,
R¹=is the same or different and is selected from the group consisting of hydrogen, alkyl, allyl, aryl, hydroxyl and radicals with photosensitive and/or thermosensitive groups such as acrylates,
R²=is the same or different and is selected from the group consisting of hydrogen, alkyl, allyl, aryl, hydroxyl and radicals with photosensitive and/or thermosensitive groups such as acrylates and,
n, m=independently of one another are 0, 1, 2, . . . and the sum of n and m corresponds to the valency of E.

6. Method according to claim 1, in which the energetic activation takes place through thermal or photolytic activation.

7. Method according to claim 6, in which the thermal activation takes place through irradiation or heating.

8. Method according to claim 6, in which the photolytic activation takes place through irradiation.

9. Method according to claim 8, in which the precursor material is irradiated with electromagnetic radiation of up to 1000 μm maximum or with particle radiation up to 1000 GeV maximum.

10. Method according to claim 9, in which the wavelength of the electromagnetic radiation is 100 to 280 nm.

11. Method according to claim 9, in which the electromagnetic radiation is emitted by a UV excimer laser.

12. Method according to claim 11, in which the irradiation takes place with a pulse duration of at least 1 ns.

13. Method according to claim 11, in which the irradiation takes place with a pulse fluence of 1 to 1000 mJ/cm².

14. Method according to claim 11, in which the irradiation takes place with a repetition rate of at least 0.01 Hz.

15. Method according to claim 11, in which the irradiation takes place with a laser pulse count of 1 to 20 000.

16. Method according to claim 7, in which the precursor material is heated with a hot plate or an oven.

17. Method according to claim 16, in which heating is to a temperature of 299 K to 2073 K, preferably 368 K to 603 K.

18. Method according to claim 1, in which the matrix is a supporting substrate with a planar or curved surface.

19. Method according to claim 18, in which the matrix is a capillary, preferably a glass capillary, into which the precursor material is introduced and which is then optionally sealed at both ends after said introduction.

20. Method according to claim 1, in which after the exposure to the action of energy the formed tips are treated with a vacuum.

21. Needle-shaped tips, the order of magnitude of which lies in the micro- and/or nanometer range, which can be obtained by a method according to claim 1.

22. Use of tips according to claim 21 as a component in a microscope, in particular in a scanning force microscope or an optical scanning nearfield microscope.

23. Use of tips according to claim 21 as microprobes for writing and reading optical and magnetic data carriers, as embossing or master structures for shaping or microprocessing soft surfaces, as microelectrodes for the emission of electron radiation or for microfuel cells or electrolysis cells, as crystallization points, as components of microactuators or for building up functional surfaces.
